(19) United States
(12) Patent Application Publication
(10) Pub. No.: US 2014/0358629 A1
(43) Pub. Date: Dec. 4, 2014

(54) COMPETITIVE PRICING PLATFORM AND MANAGED INVENTORY REPOSITORY

(71) Applicants: Gurudatta Horantur Shivaswamy, Saratoga, CA (US); Gaurav Kukal, San Jose, CA (US); Arun Lakshminarayanan, San Jose, CA (US); Amit Reoven Menipaz, Los Gatos, CA (US); Jaino Joseph, San Jose, CA (US); Lili Yuan, San Jose, CA (US)

(72) Inventors: Gurudatta Horantur Shivaswamy, Saratoga, CA (US); Gaurav Kukal, San Jose, CA (US); Arun Lakshminarayanan, San Jose, CA (US); Amit Reoven Menipaz, Los Gatos, CA (US); Jaino Joseph, San Jose, CA (US); Lili Yuan, San Jose, CA (US)

(21) Appl. No.: 14/101,141

(22) Filed: Dec. 9, 2013

Related U.S. Application Data
(60) Provisional application No. 61/829,939, filed on May 31, 2013.

(51) Int. Cl. G06Q 30/02; G06Q 10/08

(52) U.S. Cl. CPC G06Q 30/0201; G06Q 10/087
USPC 705/7.29

(57) ABSTRACT

Techniques for competitive pricing analysis and inventory management are described. According to various exemplary embodiments, a competitive pricing system is configured to crawl competitor websites for comparative pricing information at various time intervals. Moreover, the competitive pricing system is configured to determine if a price for an item on a home retailer website represents a “deal”, based on information crawled from competitor websites. According to various exemplary embodiments, a managed inventory repository system may enable improved identification of deals and specials within an inventory of a retailer website. For example, the managed inventory repository system may perform data mining operations to identify deals or specials offered for inventory items on a home retailer website. In some embodiments, a “special” can be defined in a variety of ways to suit different business units, campaigns, metrics, etc.

### CLAIM OF PRIORITY

This application claims the benefit of priority to U.S. Provisional Patent Application Ser. No. 61/829,939, filed on May 31, 2013, which is incorporated by reference herein in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

The present application relates generally to data processing systems and, in one specific example, to techniques for competitive pricing analysis and inventory management.

### BACKGROUND

Conventional retailer websites allow shoppers to browse through a wide variety of products available for sale online. Each retailer website typically hosts multiple product listing webpages that offer various products for sale. Moreover, each retailer website generally maintains its own inventory of products.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed;

FIG. 2 is a block diagram of an example system, according to various embodiments;

FIG. 3 is a flowchart illustrating an example method, according to various embodiments;

FIG. 4 illustrates an example of an item listing webpage hosted by a retailer website, according to various embodiments;

FIG. 5 illustrates an exemplary portion of a user interface, according to various embodiments;

FIG. 6 illustrates exemplary price comparison information, according to various embodiments;

FIG. 7 is a flowchart illustrating an example method, according to various embodiments;

FIG. 8 illustrates an exemplary portion of a user interface, according to various embodiments;

FIG. 9 is a flowchart illustrating an example method, according to various embodiments;

FIG. 10 is a flowchart illustrating an example method, according to various embodiments;

FIG. 11 is a block diagram of an example system, according to various embodiments;

FIG. 12 illustrates an exemplary portion of a user interface, according to various embodiments;

FIG. 13 illustrates an exemplary portion of a user interface, according to various embodiments;

FIG. 14 is a flowchart illustrating an example method, according to various embodiments;

FIG. 15 illustrates an exemplary portion of an item listing webpage, according to various embodiments;

FIG. 16 illustrates an exemplary mobile device, according to various embodiments; and

FIG. 17 is a diagrammatic representation of a machine in the example form of a computer system within which a set of instructions, fur causing the machine to perform any one or more of the methodologies discussed herein, may be executed.

### DETAILED DESCRIPTION

Example methods and systems for competitive pricing analysis and inventory management are described. In the following description, for purposes of explanation, numerous specific details are set forth in order to provide a thorough understanding of example embodiments. It will be evident, however, to one skilled in the art that the present invention may be practiced without these specific details.

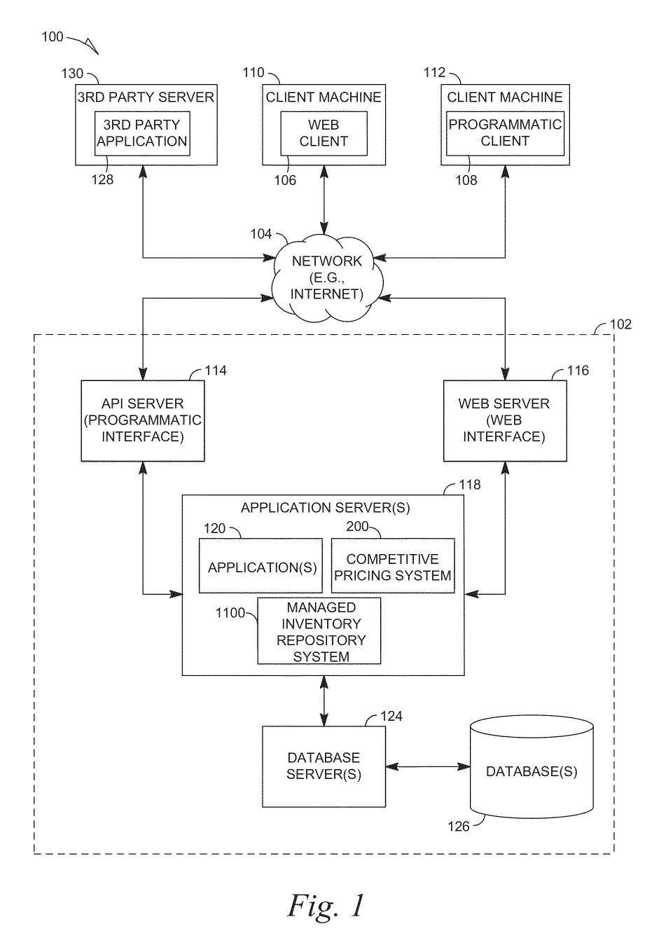

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

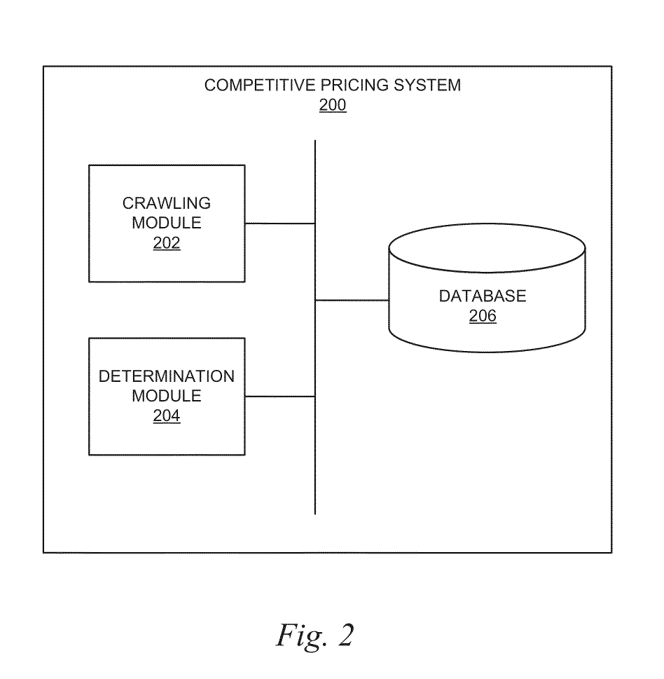

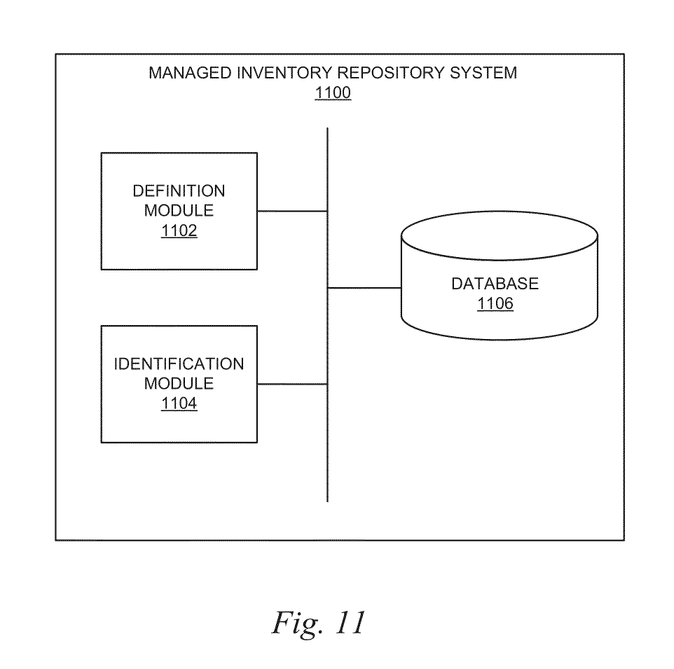

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may be implemented on or executed by one or more of the modules of the competitive pricing system 200 illustrated in FIG. 2 or the managed inventory repository system 1100 illustrated in FIG. 11. While the applications 120 are shown in FIG. 1 to form part of the networked system 102, it will be appreciated that, in alternative embodiments, the applications 120 may form part of a service that is separate and distinct from the networked system 102. With some embodiments, the application servers 118 hosts what is referred to herein as a competitive pricing system 200 and a managed inventory repository system 1100. The competitive pricing system 200 and the managed inventory repository system 1100 are described in more detail below in conjunction with the various figures.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

According to various exemplary embodiments, a competitive pricing system is configured to crawl competitor websites for comparative pricing information at various time intervals. For example, the competitive pricing system may be associated with a first marketplace or retailer website (e.g., eBay, Amazon, etc.), and may access an inventory of products available for sale on the first retailer website. The competitive pricing system may then crawl other retailer websites (e.g., competitor retailer websites) to detect and monitor competitor prices for those products that are available for sale on the first retailer website. As described throughout, the retailer website to which the competitive pricing system 200 is associated with may be referred to herein as a “first” or “home” retailer website, whereas a distinct competitor retailer website being crawled by the competitive pricing system 200 may be referred to herein as a “second” or “competitor” retailer website, in the interests of clarity.

According to various exemplary embodiments, the competitive pricing system is configured to determine if a price for an item on a home retailer website (e.g., eBay.com) represents a “deal”, based on information crawled from competitor websites. More specifically, a product offered for sale on the home retailer website is classified as a “deal” when the competitive pricing system 200 determines that the price is competitive and has a strong likelihood of attracting a sale, in comparison to competitor prices for the equivalent product. For example, if the home retailer website price for a given product is lower than a competitor price for the same product, then the home retailer website price for the given product may be considered a “deal”. In some embodiments, shipping costs, taxes, and other ancillary costs may also be taken into account in the price comparison process.

According to various exemplary embodiments, the competitive pricing system may crawl for competitor prices at various time intervals. For example, the competitive pricing system may crawl for competitor prices for a plurality of products at the same regular time interval (e.g., once a day). In other embodiments, the competitive pricing system may crawl for competitor prices at variable/adjustable time intervals, based on different products in the inventory of the home retailer website. For example, for high demand products on the home retailer website (e.g., the top X % selling products on eBay), prices may be monitored at competitor sites and marked in semi-real time (e.g., every few hours, since many competitors change prices for popular items multiple times a day). The frequency of price monitoring/collection can be adjusted (e.g., for less popular products, the competitor price can be crawled once every few days). As described in more detail below, the competitive pricing system 200 may display a user interface allowing a user of the competitive pricing system 200 to specify competitor websites to be crawled, the periodic time intervals for crawling such competitor websites, and definition information for defining the characteristics of a “deal”.

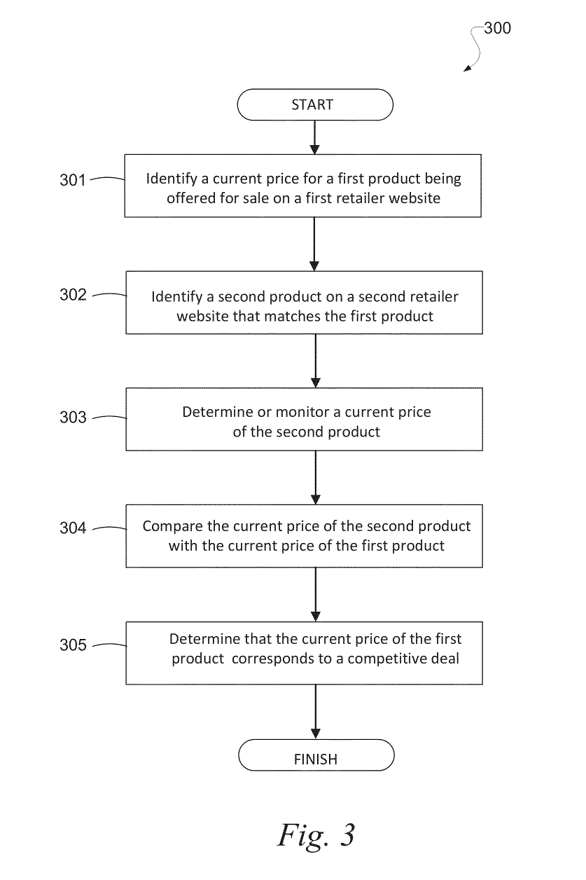

FIG. 3 is a flowchart illustrating an example method 300, consistent with various embodiments described above. The method 300 may be performed at least in part by, for example, the competitive pricing system 200 illustrated in FIG. 2 (or an apparatus having similar modules, such as client machines 110 and 112 or application server 118 illustrated in FIG. 1). In operation 301 in FIG. 3, the crawling module 202 identifies a current price for a first product being offered for sale on a first retailer website. For example, the crawling module 202 may access a database (e.g., the database 206 illustrated in FIG. 2) associated with the first retailer website that identifies various item listing pages and products offered for sale via the first retailer website.

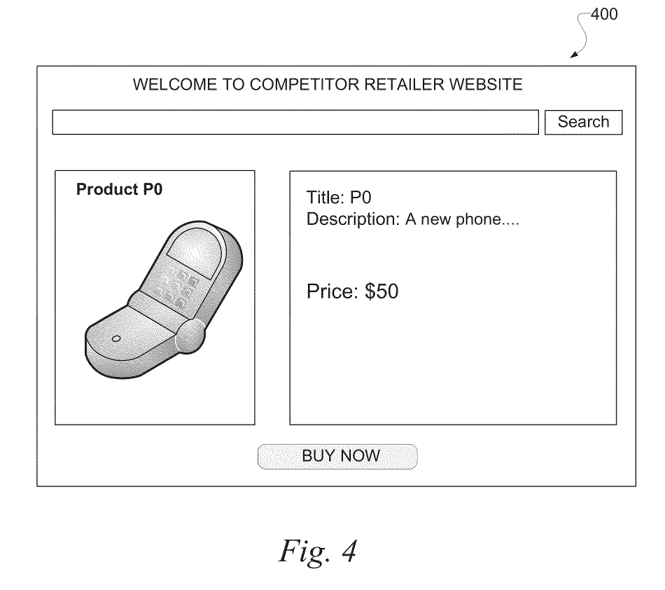

In operation 302 in FIG. 3, the crawling module 202 identifies a second product in a product inventory of a second retailer website (e.g., a competitor to the first retailer website) that matches the first product and that is offered for sale on a product listing page hosted by the second retailer website. For example, the crawling module 202 may perform a crawling operation to crawl webpages (e.g., item listing pages) associated with the second retailer website, where each of the product listing webpages may describe a specific product offered for sale on the second retailer website. For example, FIG. 4 illustrates an example of a product listing webpage 400 of a competitor retailer website that describes a particular product P0 (e.g., a smartphone) for sale on the Competitor retailer website, and includes an image of the product P0 and various descriptive information about the product P0 (e.g., title, description, attributes, characteristics, properties, specifications, price, location, etc.). The crawling module 202 may crawl such product listing pages of a competitor retailer website using any techniques known by those skilled in the art. For example, web crawling may include visiting a known webpage, gathering information from the webpage, detecting reference links (e.g., Uniform Resource Locators or URLs) to additional webpages provided on the webpage, visiting the additional webpages pages, repeating the process of gathering information and detecting reference links on each of the additional webpages, and so on. Methods and techniques for crawling publicly accessible Web pages and websites are well-known, and will not be described in detail herein in order to avoid occluding various aspects of this disclosure. Accordingly, by crawling item listing webpages hosted by competitor retailer websites, the crawling module 202 may extract information from the item listing webpages describing the products offered for sale on the competitor retailer website, Thereafter, the crawling module 202 may use various deterministic techniques for identifying a match between the competitor products and the products available for sale on the home retailer website. For example, the crawling module 202 may perform comparisons based on product title, product description, product photo, product identification numbers (e.g., manufacturer part number (MPN), international standard book number (ISBN), global trade item number (GTIN), etc.), and so on.

In operation 303 in FIG. 3, the crawling module 202 determines or monitors a current price of the second product being offered for sale on the product listing page hosted by the second retailer website. For example, the crawling module 202 may analyze the information crawled from the competitor website (in operation 302), and identify pricing information therein. In some embodiments, the crawling module 202 may identify various types of pricing information, including competitor product costs, shipping costs, “buy-it-now” prices, auction bid prices, taxes, and so on. In some embodiments, the monitoring performed by the crawling module 202 may comprise repeatedly crawling the product listing page associated with the second retailer website at a specific time interval. In some embodiments, the crawling module 202 is configured to receive, via a user interface, a user specification of the specific time interval. In some embodiments, the crawling module 202 is configured to determine the specific time interval, based on a popularity score associated with the first product offered for sale on the home retailer website. For example, by analyzing sales records and purchase history information associated with the home retailer website, the crawling module 202 may assign popularity scores to each of the products offered for sale, and may adjust the crawling intervals for crawling competitor pricing information of these products accordingly.

In operation 304 in FIG. 3, the determination module 204 compares the current price of the second product offered for sale on the competitor website with the current price of the first product offered for sale on the first retailer website. In some embodiments, the price comparison of the second product and the first product may take into account a shipping cost, taxes, and other ancillary costs. In operation 305 in FIG. 3, the determination module 204 determines that the current price of the first product offered for sale on the first retailer website corresponds to a deal, based on the comparison perform an operation 304.

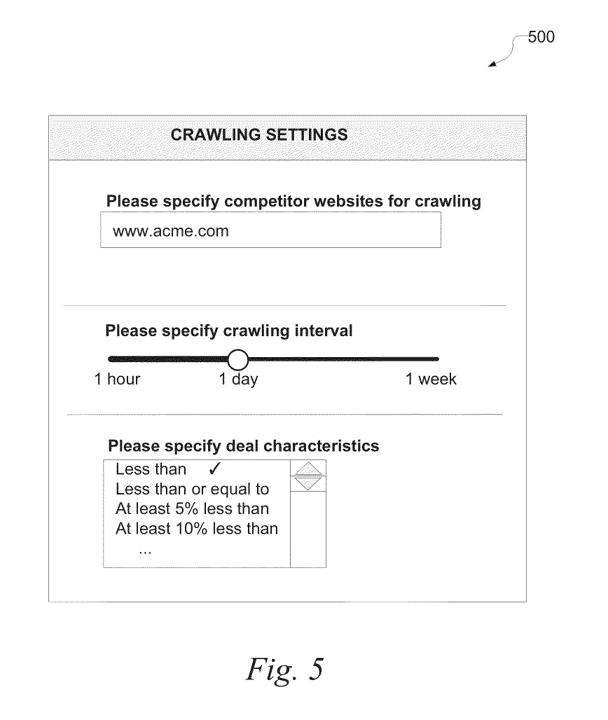

As described above, the competitive pricing system 200 may display a user interface allowing a user to specify competitor websites to be crawled, the periodic time intervals for crawling such competitor websites, and definition information for defining the characteristics of a “deal”. For example, FIG. 5 illustrates an exemplary user interface provided by the competitive pricing system 200 that allows a user to adjust various crawling settings for crawling the product listing webpages of competitor websites. The user interface 500 allows the user to specify one or more competitor websites for crawling (e.g., “www.Acme.com”), and crawling time intervals (e.g., crawl competitor website once every hour, once a day, once a week, etc.). Moreover, the user interface 500 allows a user to specify various characteristics of a “deal”. For example, as illustrated in FIG. 5, the user may specify via the user interface 500 that if the price of a product posted on the home retailer website is less than the price of the equivalent product as posted on a crawled competitor website, then the price of the product posted on the home retailer website should be classified as a “deal”.

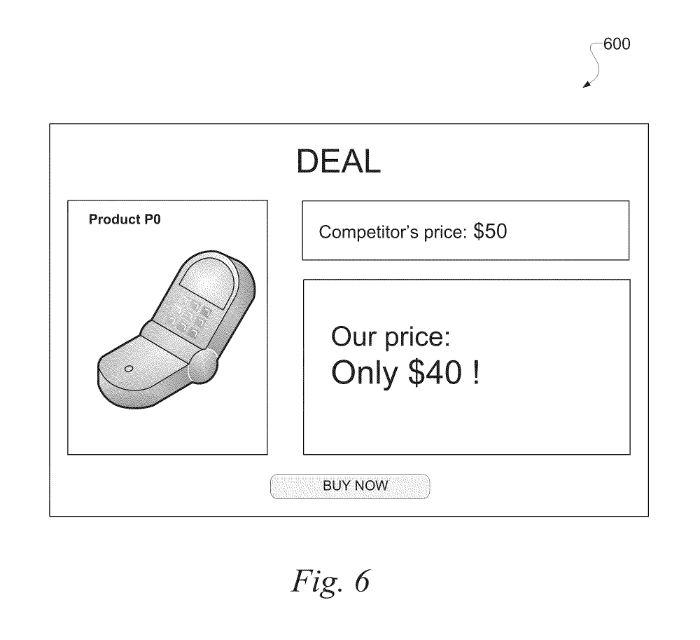

According to various exemplary embodiments, after the competitive pricing system determines that the home retailer website price for a given product item is a “deal”, the competitive pricing system is configured to promote this deal various ways. For example, the competitive pricing system may expose advertisements to potential buyers indicating the home retailer website price for the product, the competitor's price for the product, the difference between the home retailer website price and the competitor's price, and so on. For example, FIG. 6 illustrates an exemplary portion of an advertisement or prompt 600 that may be displayed by the competitive pricing system 200 in the form of an advertisement or content item that may be displayed in a webpage or an e-mail. As illustrated in FIG. 6, the advertisement 600 identifies a particular product P0, as well as the competitor's price (e.g., $50), and the price on the home retailer websites (e.g., $40). Moreover, the advertisement 600 allows the user to learn more information about the underlying product and/or to purchase the underlying product from the home retailer website by, for example, selecting the “Buy Now” user interface element/button in FIG. 6. Such advertisements 600 may be displayed via the web, such as on webpages associated with the home retailer website (e.g., an item listing page for the given item) or on webpages associated with the competitor's website (e.g., an item listing page for the competitors item), or on other websites (which may be unaffiliated with the home or competitor retailer websites), or in a mobile application, and so on. In some embodiments, the advertisements may be transmitted to users via text message, instant message, or email publications. For example, the competitive pricing system may detect when users have viewed an item, saved an item, added an item to a wish list, etc., even though the user has not purchased the item. Thereafter, a “Browse But Didn't Buy” email may be transmitted to these users, the e-mail indicating the various items that users viewed, as well as the comparative pricing information as described in various embodiments herein. In some embodiments, the advertisements may be included in e-mails indicating various items determined to be of likely interest to the user (e.g., based on known preferences, interests, buying history, etc., of the user), as well as the comparative pricing information as described in various embodiments herein. In some embodiments, deals may be promoted by displaying products and/or item listing pages associated with these deals higher (or in an otherwise more prominent position/location) in a list of search results or in a content feed associated with the home retailer website.

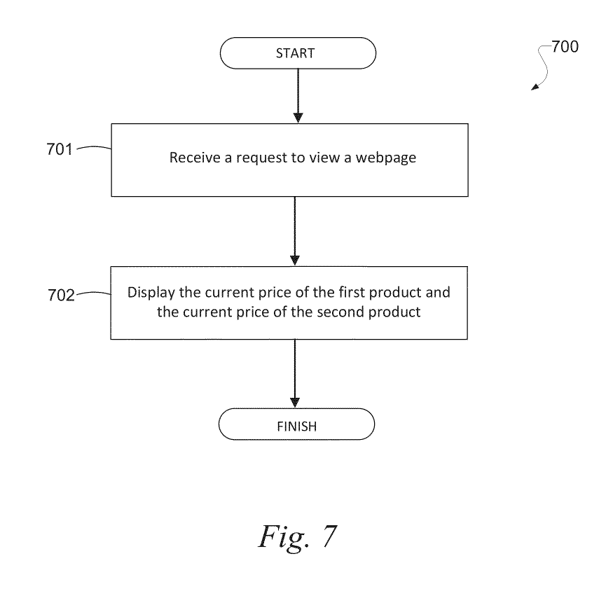

FIG. 7 is a flowchart illustrating an example method 700, consistent with various embodiments described above. The method 700 may be performed at least in part by, for example, the competitive pricing system 200 illustrated in FIG. 2 (or an apparatus having similar modules, such as client machines 110 and 112 or application server 118 illustrated in FIG. 1). In operation 701 in FIG. 7, the determination module 204 receives a request to view a webpage, such as product listing webpage for a product hosted by a home retailer website or a competitor retailer websites. In operation 702 in FIG. 7, the determination module 204 displays the appropriate webpage, where the webpage includes a prompt or advertisement identifying the current price of the product on the home retailer website and the current price of the product on the competitor retailer website. In some embodiments, the advertisement or prompt may indicate that the current price of the first product on the home retailer website corresponds to a competitive deal.

In some embodiments, the determination module 204 is configured to adjust the price for a first product available for sale on the home retailer website, based on the current price of the equivalent product on the competitor retailer website. For example, if the determination module 204 determines that the price of the first product is actually higher than the price of the equivalent product on the competitor retailer website (such that the price of the first product does not currently represent a deal), then the determination module 204 may automatically reduce the price of the first product on the home retailer website to a predetermined amount or percentage (e.g., 5%) below the competitor price. In some embodiments, the determination module 204 may display a user interface (not shown) that enables a user of the competitive pricing system 200 to specify the aforementioned predetermined amount or percentage and to provide user authorization to make automatic price adjustments. In some embodiments, the determination module 204 may transmit a message to a seller associated with first product, notifying them of the crawled competitor price and requesting permission to reduce the price of the first product as described above.

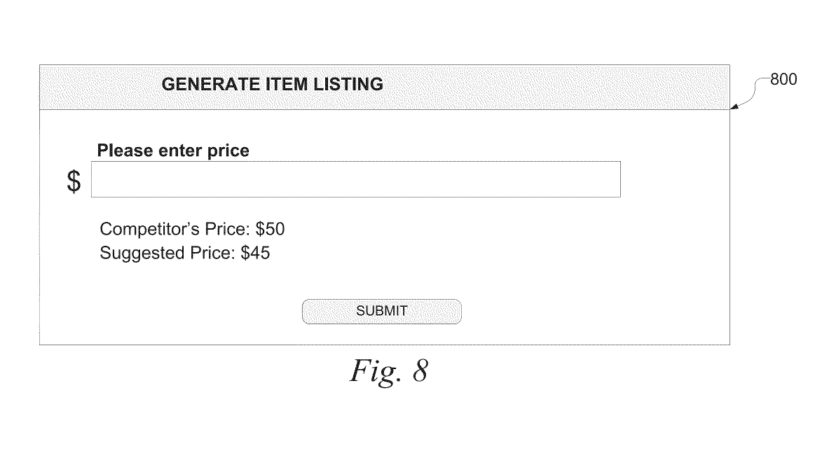

According to various exemplary embodiments, the competitive pricing system may provide advice to setters as to competitive prices for products. For example, if a competitors current price for a product item is $X, the competitive pricing system may suggest that the seller offers the product item for a price slightly lower than $X. For example, FIG. 8 illustrates an example of a user interface or prompt 800 that may be displayed by the determination module 204 to a seller of the home retailer website, such as when the seller is attempting to generate a new item webpage for a product that they are trying to sell on the home retailer website. As illustrated in FIG. 8, the prompt 800 allows the seller to specify a price of the product that they're trying to sell, and identifies a crawled competitor's price for the equivalent product (as determined by the competitive pricing system 200 in accordance with various embodiments described herein), as well as a suggested price (e.g., a predetermined amount or percentage below the corresponding competitor's price).

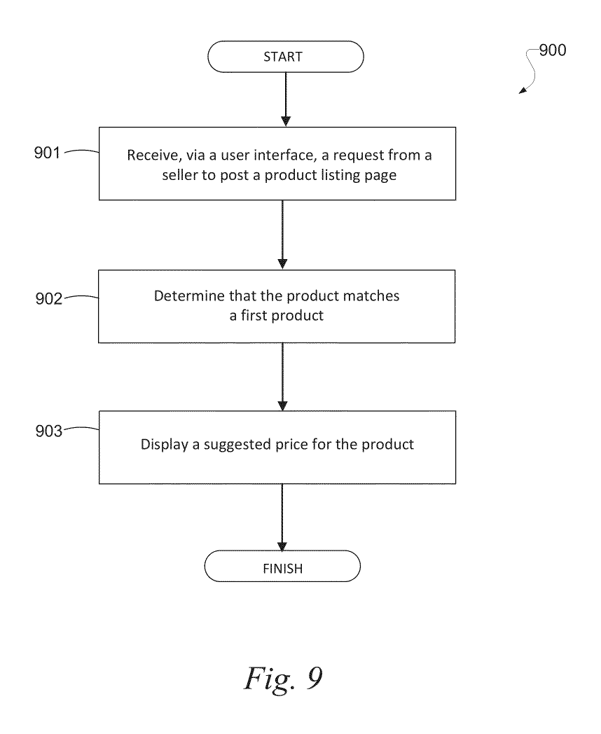

FIG. 9 is a flowchart illustrating an example method 900, consistent with various embodiments described above. The method 900 may be performed at least in part by, for example, the competitive pricing system 200 illustrated in FIG. 2 (or an apparatus having similar modules, such as client machines 110 and 112 or application server 118 illustrated in FIG. 1). In operation 901 in FIG. 9, the determination module 204 receives, via a user interface, a request from a seller to post a product listing page for a product on a home retailer website. In operation 902 in FIG. 9, the determination module 204 determines that the product matches a first product in the product inventory of the home retailer website. In operation 903 in FIG. 9, the crawling module 202 displays a suggested price for the product, based on the current price for an equivalent product offered for sale on a second (e.g., competitor) retailer website.

In some embodiments, the competitive pricing system may include a “faircasting” feature for determining trending items at competitor retailer websites based on various demand signals crawled from competitors. For example, the competitive pricing system may crawl competitor websites to determine product items that are listed on a competitor's bestseller list, “hot items” list, trending now list, etc. As another example, the competitive pricing system may crawl competitor retailer websites to detect and identify product items that are listed as “Out Of Stock” on a competitor retailer website. Based on this information, the competitive pricing system may infer that this product item is currently trending as a popular item on the competitor retailer website. Accordingly, the competitive pricing system may infer that these product items are currently trending as popular items generally, and such products can then be promoted accordingly on the home retailer website (e.g., in search results), consistent with various embodiments above.

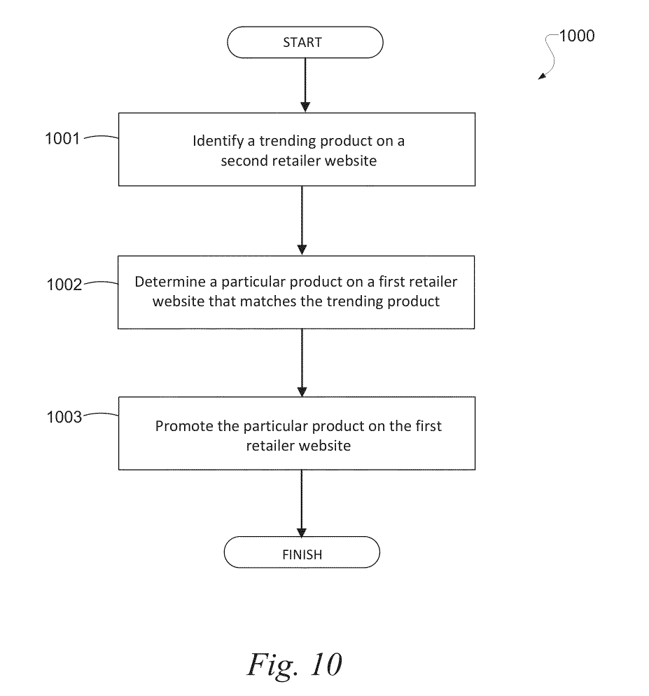

FIG. 10 is a flowchart illustrating an example method 1000, consistent with various embodiments described above. The method 1000 may be performed at least in part by, for example, the competitive pricing system 200 illustrated in FIG. 2 (or an apparatus having similar modules, such as client machines 110 and 112 or application server 118 illustrated in FIG. 1). In operation 1001 in FIG. 10, the crawling module 202 identifies a trending product on a competitor retailer website, based on crawling the competitor retailer website. In some embodiments, the trending product is identified by detecting the trending product in a bestseller list on the competitor retailer website. In some embodiments, the trending product is identified by detecting an out of stock designation associated with the trending product on the competitor retailer website. In operation 1002 in FIG. 10, the determination module 204 determines a particular product on the first retailer website that matches the trending product. For example, based on information crawled from the competitor website (in operation 1001), the determination module 204 may extract information describing the product offered for sale on the competitor retailer website. Thereafter, the determination module 204 may use various deterministic techniques for identifying a match between the competitor products and the products available for sale on the home retailer website. For example, the determination module 204 may perform comparisons based on product title, product description, product photo, product identification numbers (e.g., manufacturer part number (MPN), international standard book number (ISBN), global trade item number (GTI and), etc.). In operation 1003 in FIG. 10, the determination module 204 promotes the particular product on the home retailer website. In some embodiments, the promoting comprises causing the particular product (or an item listing page associated with the particular product) to appear higher in a content feed or search results associated with the home retailer website.

Turning now to FIGS. 11 through 14, a managed inventory repository system is described in more detail. According to various exemplary embodiments, a managed inventory repository system enables various teams and business units associated with a marketplace or retailer website (e.g., eBay, Amazon, etc.), such as marketing teams, search teams, or other business units, to improve identification of deals and specials within an inventory of the retailer website. Accordingly, these various teams may be enabled to efficiently promote deals and specials to users of the retailer website.

According to various exemplary embodiments, the managed inventory repository system is configured to perform data mining operations to identify deals or specials offered for inventory items on a home marketplace or retailer website (e.g., eBay.com). In some embodiments, a “special” can be defined in a variety of ways to suit different business units, campaigns, metrics, etc. Examples of a “special” includes lowest price, limited edition, trusted seller tagged an item as special, 20% lower than identified competitor, special configuration from the manufacturer, etc. The managed inventory repository system may access special deal definition information describing various definitions of various types of specials, consistent with various embodiments described above. Such definition information may be stored in a data repository or Web server accessible by the managed inventory repository system via a network (e.g., the Internet).

In some embodiments, the managed inventory repository system may perform real-time data comparison against competitor prices on competitor websites to confirm that there really is a “special” deal for the given item. For example, if the competitor's price for the item is higher or significantly higher than a home retailer website's (e.g., eBay's) price for the item, then the managed inventory repository system may confirm that the home retailer website's price for the item is indeed a “special”. On the other hand, if the competitor's price for the item is lower or significantly lower than the home retailer website's price for the item, then the managed inventory repository system may confirm that the home retailer website's price for the item is not a “special”.

According to various exemplary embodiments, the managed inventory repository system may store information regarding all special items identified by the system within a managed inventory data repository. The data repository may contain different parameters defining how each of the identified inventory items is “special”, such as by business unit (deals from the manufacturer), comparative pricing (e.g., 20% lower than Amazon), or seller tagged “special” (e.g., trusted seller metrics). In some embodiments, the managed inventory repository system may display a user interface allowing a user to specify different parameters defining how an item may be considered “special”, and the managed inventory repository system may display matches or hits of all the items in the inventory that may be considered “special” under the specified parameters. For example, the user interface displayed by the managed inventory repository system may allow a user to specify “show me all products that a manufacturer defines as a special”, or “show me all products that are priced 20% lower than Amazon”, or “show me all products that a seller tagged as “special”, and so on. Accordingly, marketing teams, search teams, or other business units interested in a campaign can pose queries to the repository requesting the “specials” that match the particular parameters associated with the campaign. In some embodiments, once a special deal is accessed, the special deal may be promoted to potential buyers, as described in various embodiments throughout.

In some embodiments, the proposed managed inventory repository system may provide improvements over conventional data mining techniques for discovering deals, which typically involves manually searching an inventory for terms like “limited edition”, or manually searching an inventory for the lowest price (which is a traditional way to identify “specials” matching a campaign).

In some embodiments, the managed inventory repository system may be configured to store and/or access different definitions of what constitutes a “special”. In some embodiments, the managed inventory repository system may allow inventory items to be compared against each other to determine whether one item really is a “special” relative to other inventory items. In some embodiments, the managed inventory repository system may allow comparisons against items outside the inventory e.g., against competitors) to be performed, to determine whether one item really is a “special” relative to competitor items. Accordingly, the resulting repository comprises an accurate, complete, and query-friendly identification of all “special” items within the inventory at a given point in time.

According to various exemplary embodiments, the managed inventory repository system described above may be implemented together or in conjunction with the competitive pricing system described above. The competitive pricing system and/or the managed inventory repository system may be implemented the client device, a server, a mobile device, or any other device described in conjunction FIG. 1.

Turning now to FIG. 11, the managed inventory repository system 1100 includes a definition module 1102, and identification module 1104, and a database 1106. The modules of the managed inventory repository system 1100 may be implemented on or executed by a single device such as an inventory repository management device, or on separate devices interconnected via a network. The aforementioned inventory repository management device may be, for example, one of the client machines (e.g. 110, 112) or application server(s) 118 illustrated in FIG. 1. Note that white the managed inventory repository system 1100 is illustrated as separate from the 300 in FIG. 1, it is understood that in various embodiments, the functionality of the managed inventory repository system 1100 and 300 may be combined.

According to various exemplary embodiments, the definition module 1102 of the managed inventory repository system 1100 is configured to receive a user specification of a definition of a special deal. The identification module 1104 of the managed inventory repository system 1100 is then configured to identify the item listings in the product inventory of a home retailer website (e.g., eBay.com) that correspond to special deals. For example, the identification module 1104 may identify item listings on the home retailer website that satisfy the definition of a special deal that was received by the definition module 1102. Moreover, the identification module 1104 may be configured to display, via a user interface, the special deals that were identified.

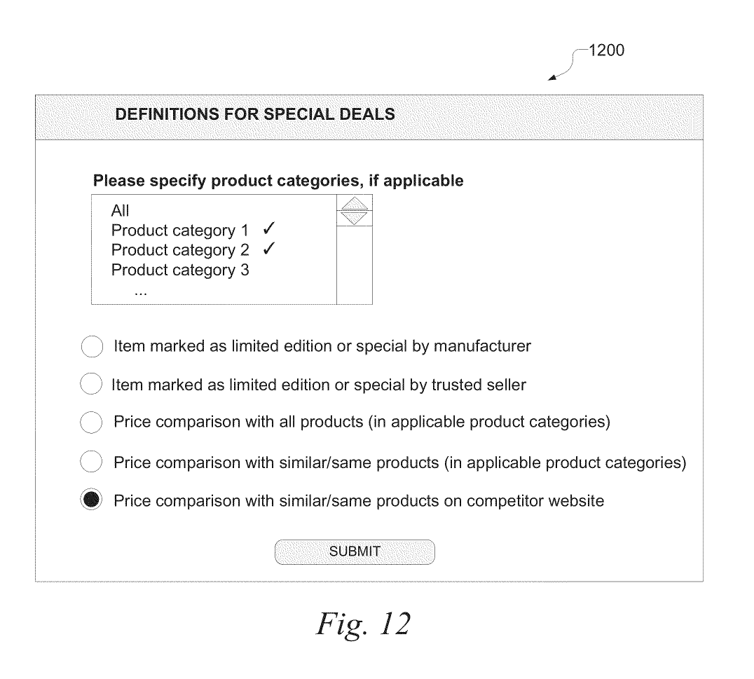

For example, FIG. 12 illustrates an exemplary user interface or prompt 1200 that may be displayed by the definition module 1102 to a user of the managed inventory repository system 1100 to enable the user to specify various definitions of “specials”. As illustrated in FIG. 12, the user may specify a particular definition of a special by first selecting an applicable product category to which the particular definition applies (e.g., the user may select product category 1 and product category 2, as illustrated in FIG. 12, or the user may simply select “all” to specify all product categories in the product inventory of the home retailer website). Using the appropriate radio buttons illustrated in FIG. 12, the user may then specify the actual defining characteristics of the special. For example, the user may specify that an item listing should be marked as a special deal based on the product being marked as “limited edition”, “special”, “deal”, etc., by the manufacturer or a trusted seller, or based on a price comparison with other products in the applicable product categories (e.g., the cheapest products in each product category may be flagged as a special deal), or a based on a price comparison with the same/similar products in the applicable product category (e.g., the cheapest item listing for a specific product such as the Apple Ipod to be flagged as a special deal) or based on a comparison with the same or similar products on a competitor website (e.g., if the product is listed on the home retailer website for less than the price of the equivalent product on a competitor website, then the product on the home retailer website may be marked as a special deal, using any of the techniques described above in conjunction with the competitive pricing system 200), and so on. Although not illustrated in FIG. 12, the prompt 1200 may allow the user to specify various criteria the price comparison (e.g., less than, at least 5% less than, etc.), as well as the crawling interval and the appropriate competitor websites to be crawled for comparison purposes, similar to the user interface 500 illustrated in FIG. 5.

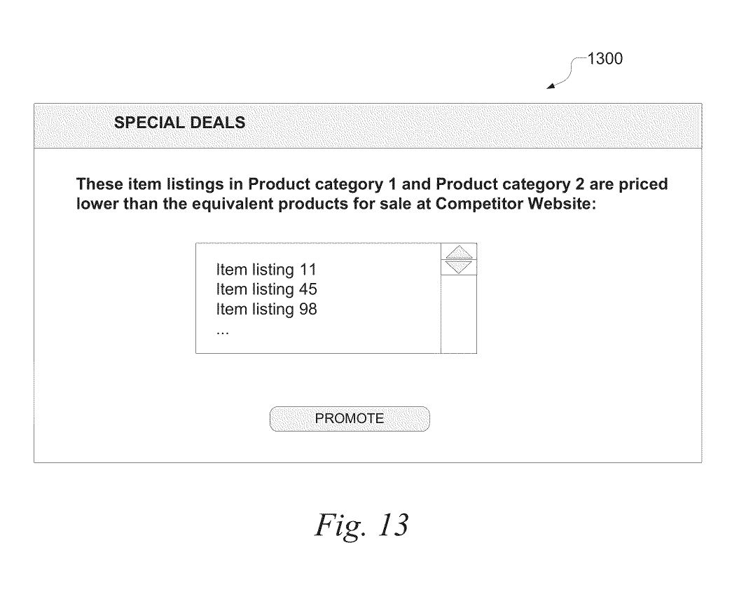

Accordingly, based on the definition information entered into the user interface 1200, the identification module 1104 will mark all products in product category 1 and product category 2 that are cheaper than the equivalent products for sale on the competitor website as a special deal. For example, FIG. 13 illustrates an exemplary user interface or prompt 1300 that identifies various item listings or products that the system has determined are special deals (e.g., based on deal definition information entered by the user via the user interface 1200 in FIG. 12). As illustrated in FIG. 13, the prompt 1300 indicates that, within product category 1 and product category 2, item listings 11, 45, 98, include products priced lower than the equivalent products for sale at a competitor website.

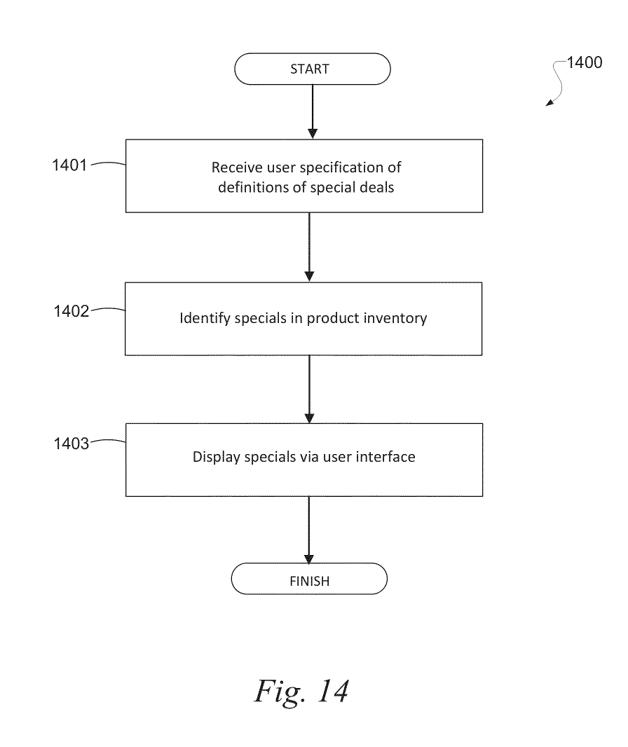

FIG. 14 is a flowchart illustrating an example method 1400, consistent with various embodiments described above. The method 1400 may be performed at least in part by, for example, the managed inventory repository system 1100 illustrated in FIG. 11 (or an apparatus having similar modules, such as client machines 110 and 112 or application server 118 illustrated in FIG. 1). In operation 1401 in FIG. 14, the definition module 1102 receives a user specification of a definition of a special deal. For example, the definition module 1102 may display the user interface 1200 in FIG. 12 in order to receive definition information defining a special deal. In some embodiments, the definition module 1102 may store this definition information in a database, such as database 1106 illustrated in FIG. 11. In operation 1402 in FIG. 14, the identification module 1104 identifies the item listings in the product inventory of a home retailer website (e.g., eBay.com) that correspond to special deals. For example, the identification module 1104 may identify item listings on the home retailer website that satisfy the definition of a special deal that was received in operation 1401. In operation 1403 in FIG. 14, the identification module 1104 displays, via a user interface, the special deals that were identified in operation 1402 (e.g., the item listings on the home retailer website that satisfy the definition of a special deal that was received in operation 1401). An example of such a user interface identifying special deals is illustrated in FIG. 13.

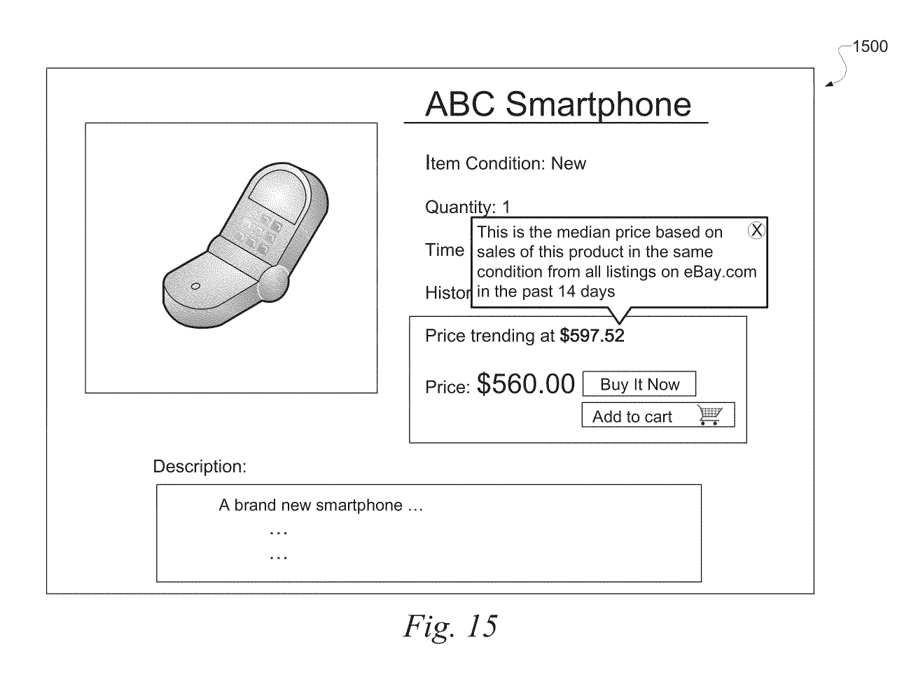

In some embodiments, in addition to identifying items as “specials” based on insights into competitive pricing benchmarks (e.g., based on various crawling techniques described above), special items may also be identified by comparing the price of a given item with various marketplace benchmarks/metrics associated with the home retailer website (e.g. eBay) itself, such as the historical median sold price for the given item on the home retailer website in the last 90 days. Such special items may be tagged as a “special” or “marketplace deal” in a repository associated with the management inventory repository system, and may be promoted to potential buyers, consistent with various embodiments throughout. For example, after identifying such special items, the managed inventory repository system may run promotions or display special treatments for these items to users on site. For instance, when a visitor to the home retailer website views an item listing page for a particular item, the management inventory repository system may determine that the item is a special (e.g., if it has been previously marked as such in the inventory associated with the managed inventory repository system), and the system may adjust a displayed item listing webpage accordingly. For example, FIG. 15 illustrates an example of a special treatment for an item determined to be priced lower than a historical median price for that item, where the item listing webpage 1500 for the item identifies the current (“special”) price as well as the median or trending price. Thus, potential buyers may be alerted to the fact that the item represents a special deal, and they may be encouraged to purchase the special item.

### Example Mobile Device

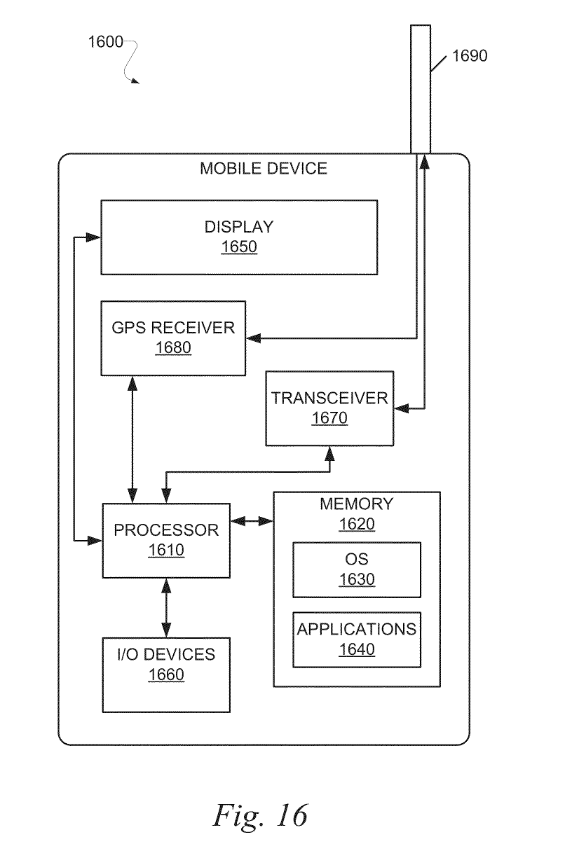

FIG. 16 is a block diagram illustrating the mobile device 1600, according to an example embodiment. The mobile device may correspond to, for example, client machines 110 and 112 or application server 118 illustrated in FIG. 1. One or more of the modules of the system 200 illustrated in FIG. 2 may be implemented on or executed by the mobile device 1600. The mobile device 1600 may include a processor 1610. The processor 1610 may be any of a variety of different types of commercially available processors suitable for mobile devices for example, an XScale architecture microprocessor, a Microprocessor without interlocked Pipeline Stages (MIPS) architecture processor, or another type of processor). A memory 1620, such as a Random Access Memory (RAM), a Flash memory, or other type of memory, is typically accessible to the processor 1610. The memory 1620 may be adapted to store an operating system (OS) 1630, as well as application programs 1640, such as a mobile location enabled application that may provide location based services to a user. The processor 1610 may be coupled, either directly or via appropriate intermediary hardware, to a display 1650 and to one or more input/output (I/O) devices 1660, such as a keypad, a touch panel sensor, a microphone, and the like. Similarly, in some embodiments, the processor 1610 may be coupled to a transceiver 1670 that interfaces with an antenna 1690. The transceiver 1670 may be configured to both transmit and receive cellular network signals, wireless data signals, or other types of signals via the antenna 1690, depending on the nature of the mobile device 1600. Further, in some configurations, a GPS receiver 1680 may also make use of the antenna 1690 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

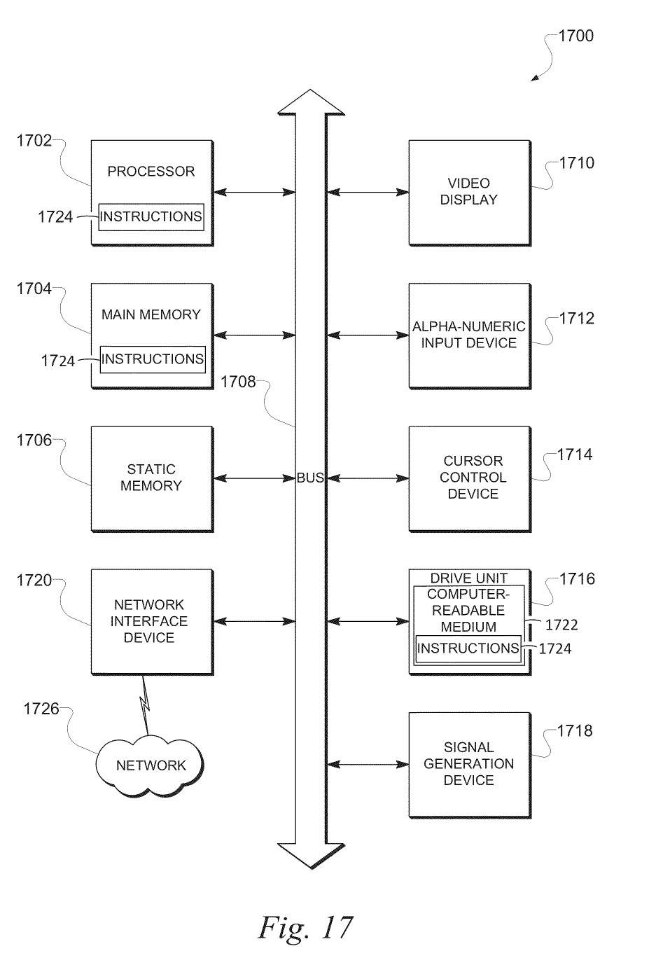

FIG. 17 is a block diagram of machine in the example form of a computer system 1700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU), a graphics processing unit (GPU) or both), a main memory 1704 and a static memory 1706, which communicate with each other via a bus 1708. The computer system 1700 may further include a video display unit 1710 (e.g., a liquid crystal display (LCD) or a cathode ray tube (CRT)). The computer system 1700 also includes an alphanumeric input device 1712 (e.g., a keyboard or a touch-sensitive display screen), a user interface (Ulf) navigation device 1714 (e.g., a mouse), a disk drive unit 1716, a signal generation device 1718 (e.g., a speaker) and a network interface device 1720.

### Machine-Readable Medium

The disk drive unit 1716 includes a machine-readable medium 1722 on which is stored one or more sets of instructions and data structures (e.g., software) 1724 embodying or utilized by any one or more of the methodologies or functions described herein. The instructions 1724 may also reside, completely or at least partially, within the main memory 1704 and/or within the processor 1702 during execution thereof by the computer system 1700, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
identifying a current price for a first product being offered for sale on a first retailer website;
identifying a second product in a product inventory of a second retailer website that matches the first product, the second product being offered for sale on a product listing page hosted by the second retailer website;
monitoring a current price of the second product being offered for sale on the product listing page hosted by the second retailer website;
comparing the current price of the second product with the current price of the first product; and
determining that the current price of the first product offered for sale on the first retailer website corresponds to a competitive deal, based on the comparison.

2. The method of claim 1, wherein the monitoring comprises repeatedly crawling the product listing page associated with the second retailer website at a specific time interval.

3. The method of claim 2, further comprising:
determining the specific time interval, based on a popularity score associated with the first product.

4. The method of claim 1, wherein the current price of the second product and the price of the first product include a shipping cost.

5. The method of claim 1, further comprising:
receiving a request to view a product listing webpage for the first product that is hosted by the retailer website; and
displaying the product listing webpage for the first product, the product listing webpage identifying the current price of the first product corresponding to the competitive deal and indicating the current price of the second product.

6. The method of claim 1, further comprising:
transmitting an email notification to a user, the email notification identifying the current price of the first product corresponding to the competitive deal and indicating the current price of the second product.

7. The method of claim 1, further comprising:
causing an advertisement to be displayed on a webpage unaffiliated with the retailer website, the advertisement identifying the current price of the first product corresponding to the competitive deal and indicating the current price of the second product.

8. The method of claim 1, thither comprising:
causing the first product to appear higher in a content feed or search results page associated with the first retailer website.

9. The method of claim 1, further comprising:
receiving, via a user interface, a request from a seller to post a product listing page for a product;
determining that the product matches the first product offered for sale on the first retailer website; and
displaying a suggested price for the product, based on the current price for the second product offered for sale on the second retailer website.

10. The method of claim 1, further comprising:
adjusting the price of the first product on the first retailer website, based on the current price of the second product.

11. The method of claim 1, further comprising:
identifying a trending product on the second retailer website, based on crawling the second retailer website;
determining a particular product on the first retailer website that matches the trending product; and
promoting the particular product on the first retailer website.

12. The method of claim 11, wherein the trending product is identified by detecting the trending product in a bestseller list on the second retailer website.

13. The method of claim 11, wherein the trending product is identified by detecting an out of stock designation associated with the trending product on the second retailer website.

14. The method of claim 11, wherein the promoting comprises:
causing the particular product to be appear higher in a content feed or search results associated with the first retailer website.

15. The method of claim 1, further comprising:
receiving a user specification of definition information defining a special deal;
identifying specials associated with products offered for sale on the first retailer website; and
displaying a list of the specials.

16. An apparatus comprising:
a crawling module configured to:
identify a current price for a first product being offered for sale on a first retailer website;
identify a second product in a product inventory of a second retailer website that matches the first product, the second product being offered for sale on a product listing page hosted by the second retailer website; and
monitor a current price of the second product being offered for sale on the product listing page hosted by the second retailer website; and
a determination module configured to:
compare the current price of the second product with the current price of the first product; and
determine that the current price of the first product offered for sale on the first retailer website corresponds to a competitive deal, based on the comparison.

17. The apparatus of claim 16, wherein the monitoring comprises repeatedly crawling the product listing page associated with the second retailer website at a specific time interval.

18. The apparatus of claim 16, wherein the determination module is further configured to:
receive a request to view a product listing webpage for the first product that is hosted by the retailer website; and
display the product listing webpage for the first product, the product listing webpage identifying the current price of the first product corresponding to the competitive deal and indicating the current price of the second product.

19. A non-transitory machine-readable storage medium having embodied thereon instructions executable by one or more machines to perform operations comprising:
identifying a current price for a first product being offered for sale on a first retailer website;
identifying a second product in a product inventory of a second retailer website that matches the first product, the second product being offered for sale on a product listing page hosted by the second retailer website;
monitoring a current price of the second product being offered for sale on the product listing page hosted by the second retailer website;
comparing the current price of the second product with the current price of the first product; and
determining that the current price of the first product offered fir sale on the first retailer website corresponds to a competitive deal, based on the comparison.

20. The storage medium of claim 19, wherein the monitoring comprises repeatedly crawling the product listing page associated with the second retailer website at a specific time interval.
